(19) United States
(12) Patent Application Publication
(10) Pub. No.: US 2012/0075872 A1
(43) Pub. Date: Mar. 29, 2012

(54) Emergency Response Locator Beacon

(76) Inventor: Buddy Byrne, Huntington, NY (US)

(21) Appl. No.: 13/168,934

(22) Filed: Jun. 24, 2011

Related U.S. Application Data
(60) Provisional application No. 61/358,017, filed on Jun. 24, 2010.

(51) Int. Cl. F21V 15/01

(52) U.S. Cl. 362/362

(57) ABSTRACT

An emergency response locator beacon comprising: a first enclosure to house a plurality of electrical circuitry components; a strobe light protruding through a front surface of said first enclosure in electrical communication with said plurality of electrical components; means connected to an activation switch in electrical communication with said plurality of electrical components; and means to removably attach said first enclosure and said carrier when coupled to a desired support structure.

### RELATED APPLICATION

The present application claims the benefit of the filing date of Provisional Application No. 61/358,017 filed Jun. 24, 2010.

### BACKGROUND OF THE INVENTION

1. Field of Invention

The present invention relates generally to emergency distress beacons. More particularly, it relates to a portable emergency response beacon which can used in a venue wherein an emergency situation is unfolding for the purpose of assisting emergency responders, such as police officers, firemen and EMTs to quickly and effectively locate the venue thereby preventing unnecessary loss of life.

2. Prior Art

The development and implementation of the 911 emergency response system has saved countless lives across the United States. The ability to pick up any telephone at any location and reach emergency personnel within seconds has saved lives from fire, sudden illnesses, and acts of violence. Communities with enhanced 911 systems also have the advantage of the emergency personnel knowing the address of the dialing party even if the person cannot talk. These features have led to decreased response time and a corresponding increase in saved lives.

However, while maps, response plans and GPS locators can get the emergency personnel to the general location or venue of the emergency in a quick manner, the emergency personnel must still look at street addresses to find the actual home or building wherein the emergency is unfolding. This is particularly difficult task when the emergency personnel who are responding with speed and alacrity are not familiar or otherwise knowledgeable with the geography of the area. Further it is a task which becomes even more difficult once darkness has set in, inclement weather is in place, or rural locations are overgrown with brush and contain roads that are difficult to traverse. As a result, many precious minutes are lost when the home or building cannot be located or the wrong location is entered. Accordingly, there is a need for a simple, quick and accessible means by which emergency response personnel can quickly locate a home or building that has requested emergency services through the 911 emergency response system. The development of the present invention fulfills this need.

### SUMMARY OF THE INVENTION

Accordingly, it is an object of the present invention to provide a a simple, quick, and accessible means for use by a third party or the victim during an emergency situation.

It is a further object of the present invention to provide a simple, quick, and accessible means by which emergency response personnel can quickly locate a home or building that has requested emergency services through the 911 emergency. response system.

It is yet another object of the present invention to provide an emergency response locator beacon to aid emergency personnel in locating residences or other structures when responding to a 911 call or other emergency. A primary component of the apparatus is at least one LED strobe light that is activated by a pull cord, a pull key, a remote control, or unit mounted switch. It is intended to be located by the front door, window, or porch of the structure or residence requiring assistance. The strobe light is activated immediately after calling for help, such that responding emergency crews can quickly find the location during day or night. The strobe light is of a low-voltage, high intensity design that is visible for great distances even through fog, rain, or other inclement weather. The strobe light may be optionally powered by long life batteries allowing the apparatus to work when the AC power is out or at remote locations where power is not available. It is envisioned that the apparatus be provided as. part of a first aid kit or could even be modified to automatically activate as part of an alarm, panic, elderly, or handicapped assistance system. The use of the present invention allows emergency response personnel to locate homes or buildings requiring emergency assistance in a manner that quick, easy and effective.

These and other objects, advantages, features, and characteristics of the invention will be apparent from the following description of a preferred embodiment, considered along with the accompanying drawings.

### BRIEF DESCRIPTION OF THE DRAWINGS

It is believed that the present invention will be better understood from the following detailed description taken in conjunction with the accompanying drawings, in which the numerals represent identical elements and wherein:

FIG. 1 is a perspective front view of an emergency response locator beacon 10 affixed onto a carrier 20, according to a preferred embodiment of the present invention;

FIG. 2 is a perspective rear view of the emergency response locator beacon 10 affixed onto the carrier 20, according to the preferred embodiment of the present invention;

FIG. 3a is a perspective front view of the carrier 20, according to the preferred embodiment 10 of the present invention;

FIG. 3b is a perspective rear view of the carrier 20, according to the preferred embodiment 10 of the present invention; and,

FIG. 4 is a perspective front view of a remote activator 40 for the emergency response locator beacon 10, according to the preferred embodiment 10 of the present invention.

FIG. 5 is a front plan view of the second embodiment of the emergency response locator beacon 10.

FIG. 6 is a side plan view of a second embodiment of the emergency response locator beacon 10.

FIG. 7 is one plan side view of the cover taken along the A-A axis, as used in the second embodiment of the emergency response locator beacon 10.

FIG. 8 is another plan side view of the cover taken along the B-B′ axis, as used in the second embodiment of the emergency response locator beacon 10.

FIG. 9 Top plan view of the front face of the PC board as used in the second embodiment of the emergency response locator beacon 10.

FIG. 10 Top plan view of the back face of the PC board as used in the second embodiment of the emergency response locator beacon 10.

### LIST OF ELEMENTS AND THEIR RESPECTIVE IDENTIFYING NUMERALS

| NO | ELEMENT |
|---|---|
| 10 | Emergency response locator beacon |
| 11 | First enclosure |
| 12 | Strobe Light |
| 13 | Pull ring |
| 14 | Power switch |
| 15 | Indicia |
| 16 | battery cover |
| 17 | charge status light |
| 18 | hook fastening strip |
| 19 | pull cord or pull key |
| 20 | carrier |
| 21 | Body |
| 22 | suction cup |
| 23 | hanger connection |
| 24 | hanger |
| 26 | loop fastening strip |
| 31 | light-emitting diode |
| 40 | remote activator |
| 41 | second enclosure |
| 42 | “on” button |
| 43 | “off” button |
| 44 | signal light |
| 45 | carrying cord |
| 46 | carrying ring |
| 100 | Body portion |
| 102 | Front face of Body Portion |
| 104 | Back face of Body Portion |
| 106 | Hole(s) or aperture(s) for LED(s) |
| 108 | Hole(s) or aperture(s) for suction cups of hanging chain |
| 110 | Slot(s) |
| 112 | PC board |
| 114 | PC Board front face |
| 116 | PC Board back face |
| 118 | LED light(s) |
| 120 | Spring brass actuator |
| 122 | Cover |
| 124 | Elongated hooked flanges |

### DETAILED DESCRIPTION OF THE PREFERRED EMBODIMENT

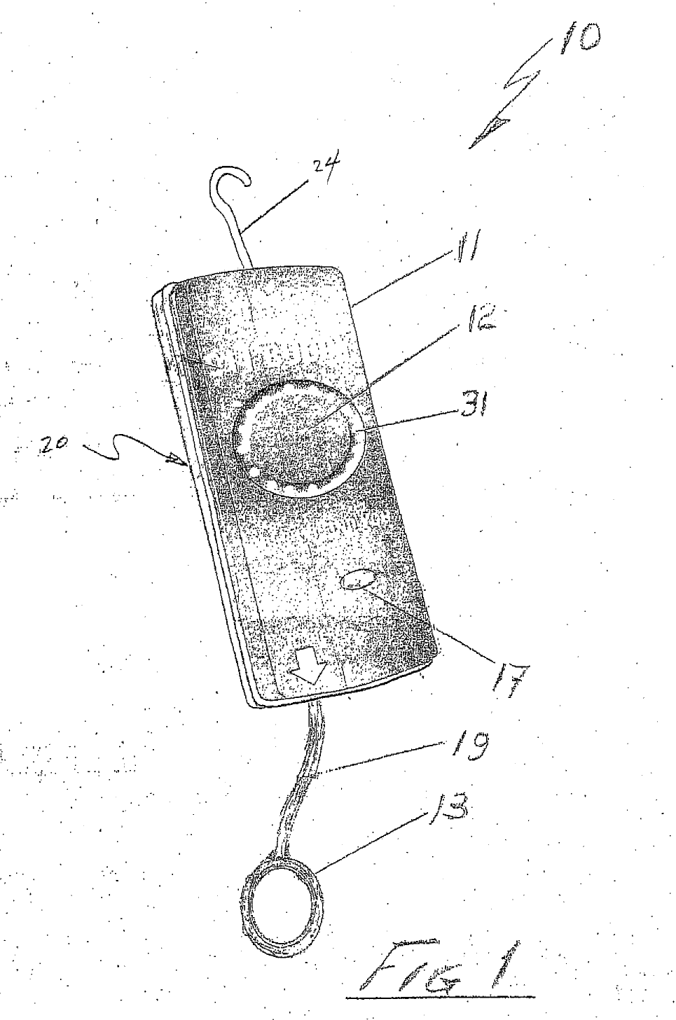

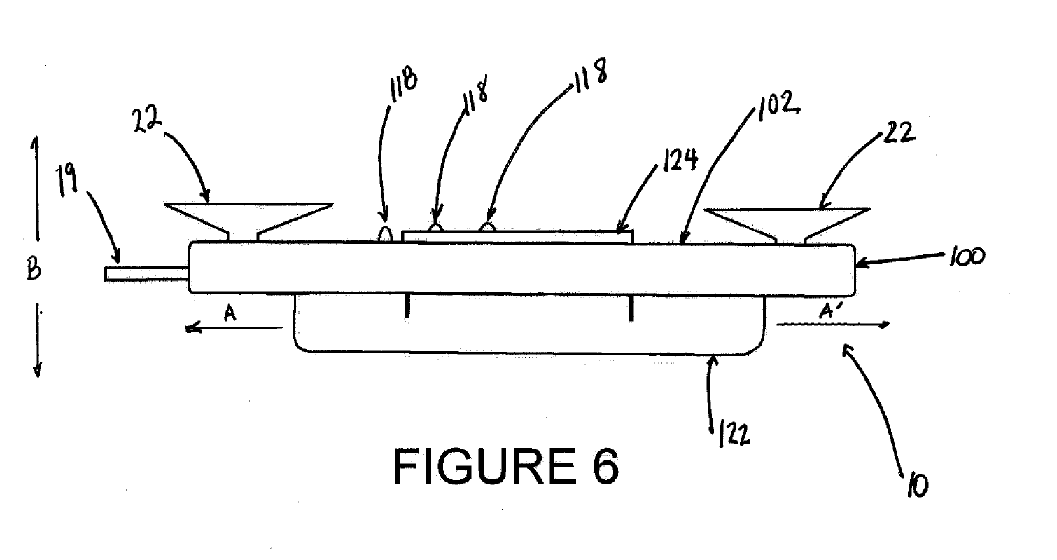

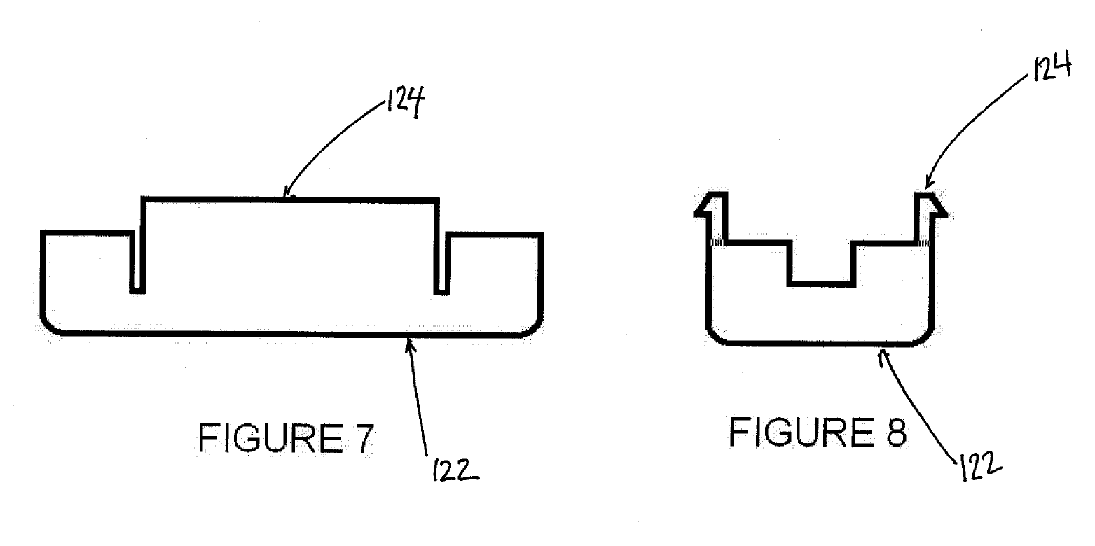

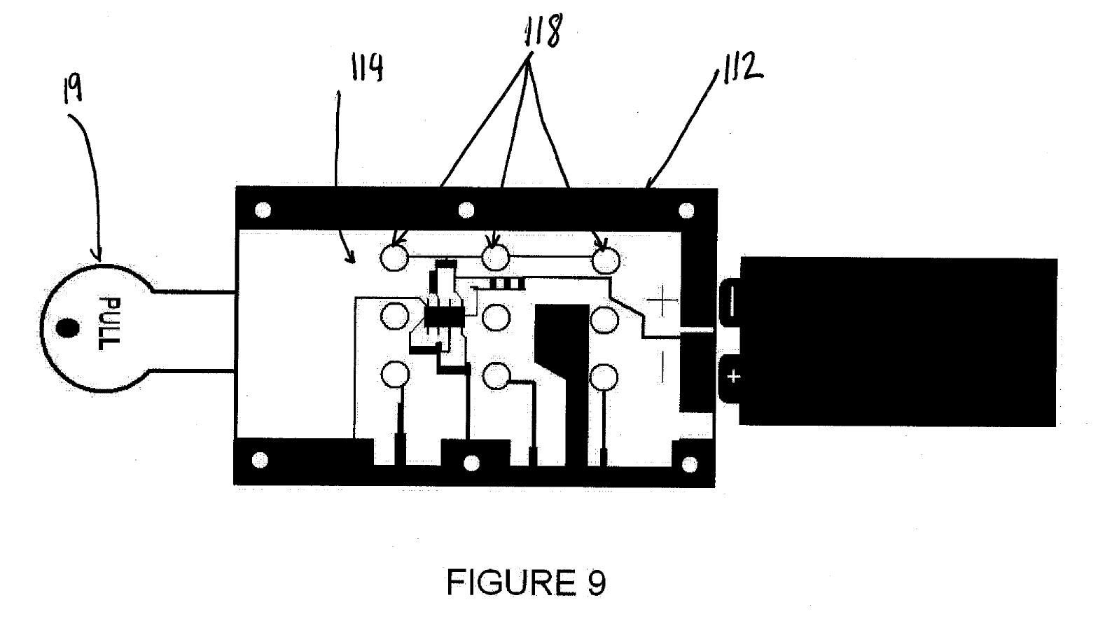

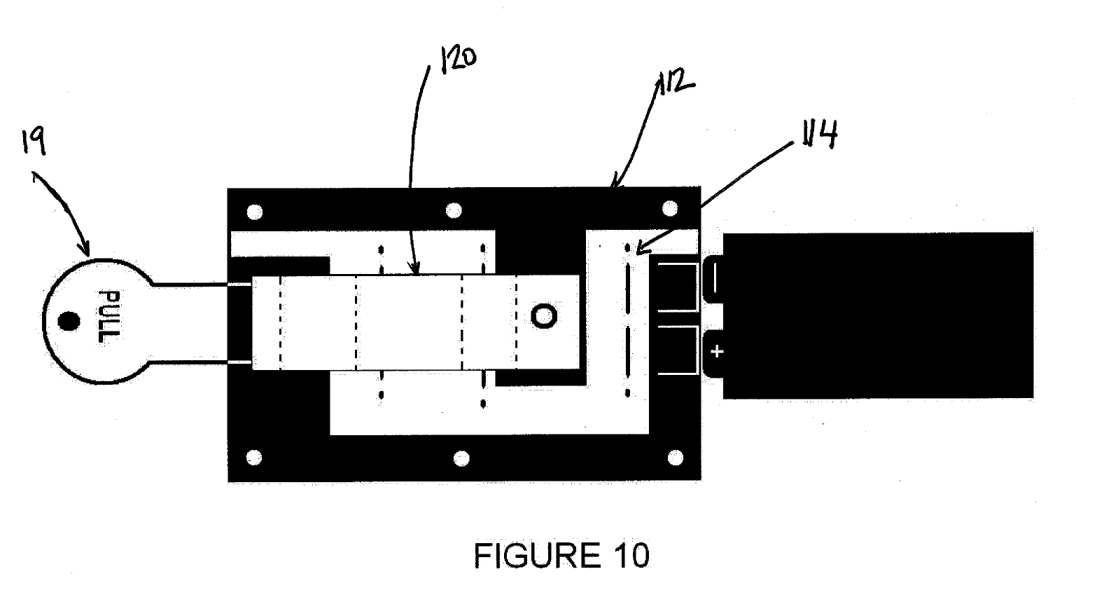

The best mode for carrying out the invention is presented in terms of its preferred embodiments, herein depicted within FIGS. 1 through 4 and FIGS. 5 through 10. However, the invention is not limited to the described embodiments, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and the particular configurations are being shown and described for purposes of clarity and disclosure and not by way of limitation of scope.

The terms “a” and “an” herein do not denote a limitation of quantity, but rather denote the presence of at least one of the referenced items. The present invention describes an emergency response locator beacon (herein 20 described as the “apparatus”) 10, which provides a means for rescue personnel to quickly and readily locate an emergency site. Referring now to FIG. 1, a perspective front view of the apparatus 10, according to one of the preferred embodiment of the present invention, is disclosed. The apparatus 10 comprises a first enclosure 11, a strobe light 12, a pull ring 13, a charge status light 17, and a pull cord 19. The interior portion of the first enclosure 11 comprises a system of electronics and a long life battery which provide the means by which the operation of the strobe light 12 is controlled and powered. The strobe light 12 comprises a plurality of light-emitting diodes (LED's) 31 which provide a low-voltage high-intensity pulsating light beam intended to attract the immediate attention of the rescue personnel and marks the site of the emergency.

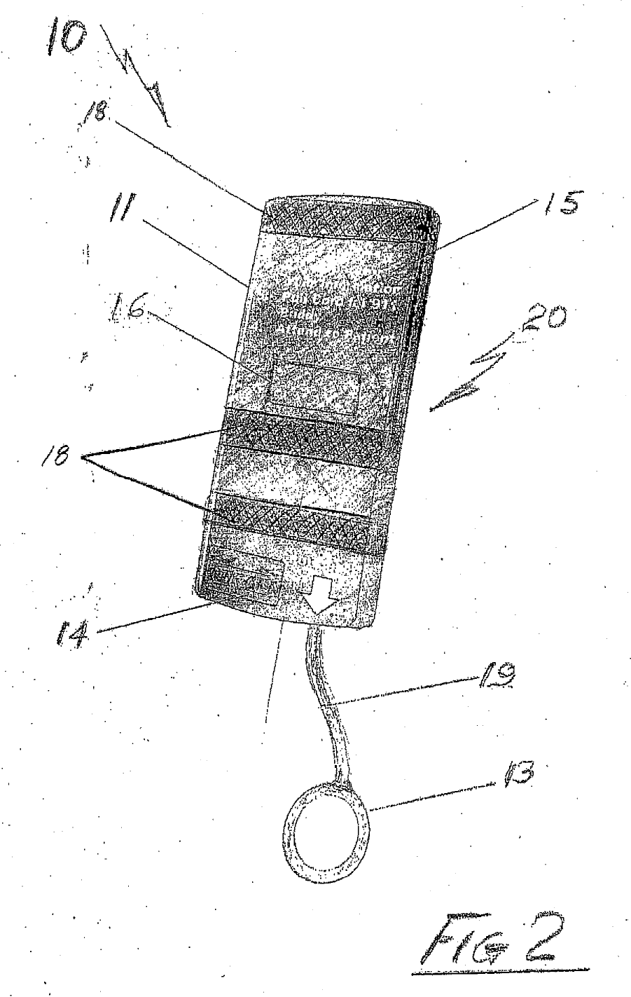

Referring now to FIG. 2, a perspective rear view of the apparatus 10, according to the preferred embodiment of the present invention, is disclosed. The apparatus 10 comprises a power switch 14, indicia 15 in the form of user instructions 15, a battery cover 16, and a plurality of hook fastening strips 18. The enclosure 11 is depicted as attached to a carrier 20 intended to provide the means to removably secure the apparatus 10 onto a structure or a vehicle, thereby marking the location of the emergency.

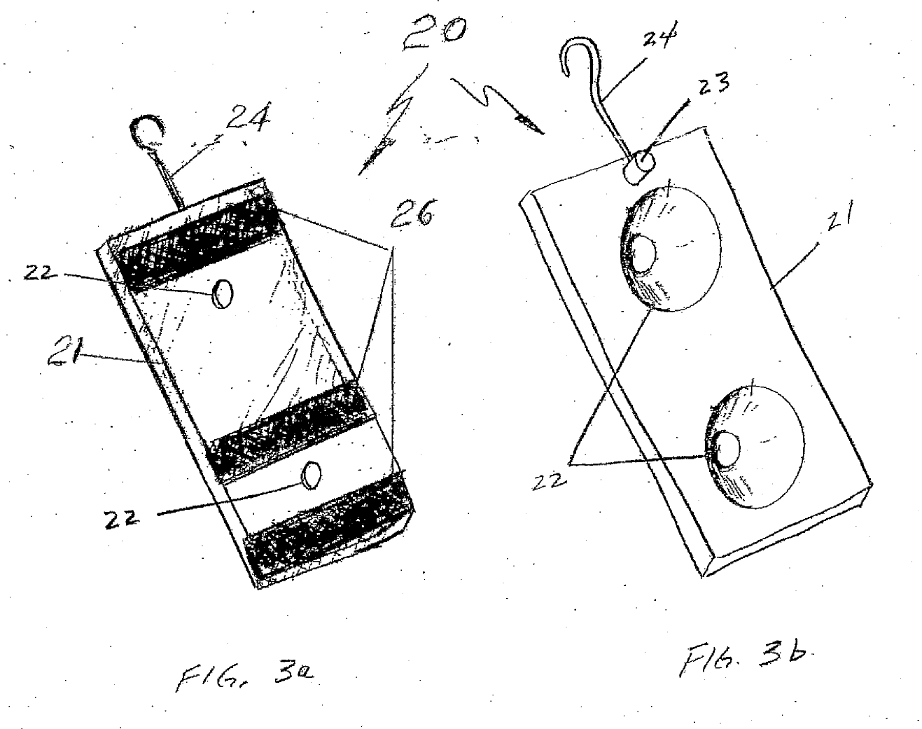

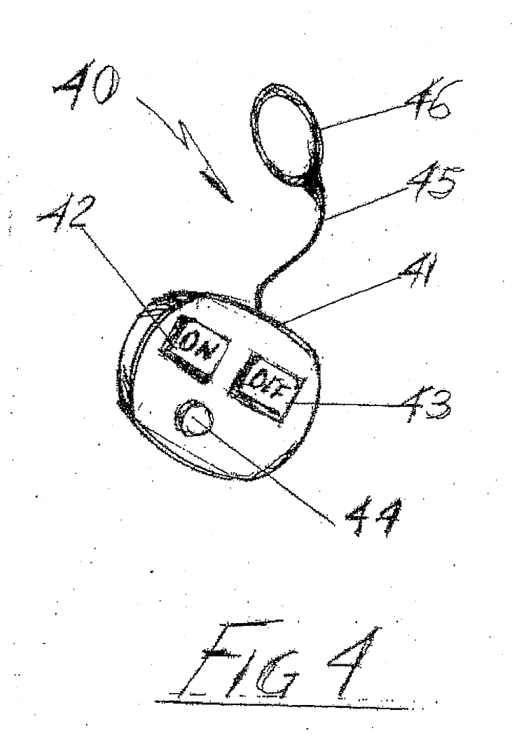

Referring now to FIGS. 3a and 3b, perspective views of the carrier 20, according to the preferred embodiment of the apparatus 10 of the present invention, are disclosed. The carrier 20 provides the apparatus 10 with the means to be readily attached onto a structure, such as, but not limited to the interior portion of a window pane or a door window by the use of a pair of suction cups 22 or alternately a hanger 24. The envisioned removable mounting of the suction cups 22 onto the body 21 allows the pair to be installed in a reverse rear facing configuration if it is anticipated that an outside fastening location is preferable. The body 21 of the carrier 20 is made of a clear plastic material to allow the indicia 15 to remain visible for a user. The suction cups 22 are each removably fastened onto the body 21 by means of threaded studs. Additionally, the carrier 20 comprises a hanger connection 23 and a hanger 24 which allow the apparatus 10 to be suspended from an overhead feature of the structure as an alternate mounting feature. The rear portion of the first enclosure 11 is securely fastened onto the front portion of the body 21 of the carrier 20 by the connection of the plurality of hook fastening strips 18 onto a corresponding plurality of loop fastening strips 26 comprised within the face portion of the body 21.

Referring now to FIG. 4, a perspective front view of the remote activator 40, according to the preferred embodiment of the apparatus 10 of the present invention, is disclosed. The remote activator 40 comprises a second enclosure 41, an “on” button 42, an “off” button 43, a signal light 44, a carrying cord 45 and a carrying ring 46. The strobe light 12 can be activated by either sliding the power switch 14 onto the “on” position, grasping the pull-ring 19 and pulling the pull-cord 19, or pushing the “on” button of the remote activator 40. The strobe light 12 is turned off by either sliding the power switch 14 onto the “off” position or pushing the “off” button of the remote 40 which generates and transmits a signal which provides the ceasing of power to the strobe light 12. The carrying cord 45 and carrying ring 46 assembly is permanently and securely fastened onto the second enclosure 40 and allows the remote activator to be either carried in a variety of manners on the person of the user, or to be suspended onto a visible and easily accessible member within a structure or a vehicle. A signal light 44 is lit to alert a remote and disabled user that the strobe light is activated.

An alternative embodiment of the present invention 10 comprises an enhanced electronic system which includes the capability to broadcast an emergency radio frequency and emit an audio signal as an additional aid in pinpointing an emergency location under adverse conditions wherein the strobe light 12 may not be readily visible, such as, but not limited to a vehicle buried within a snow drift, a vehicle having been uncontrollably propelled into a location outside of a line-of-sight, or the strobe light 12 has been remotely activated by a disabled victim who is rendered unable to install the apparatus 10 in a visible location.

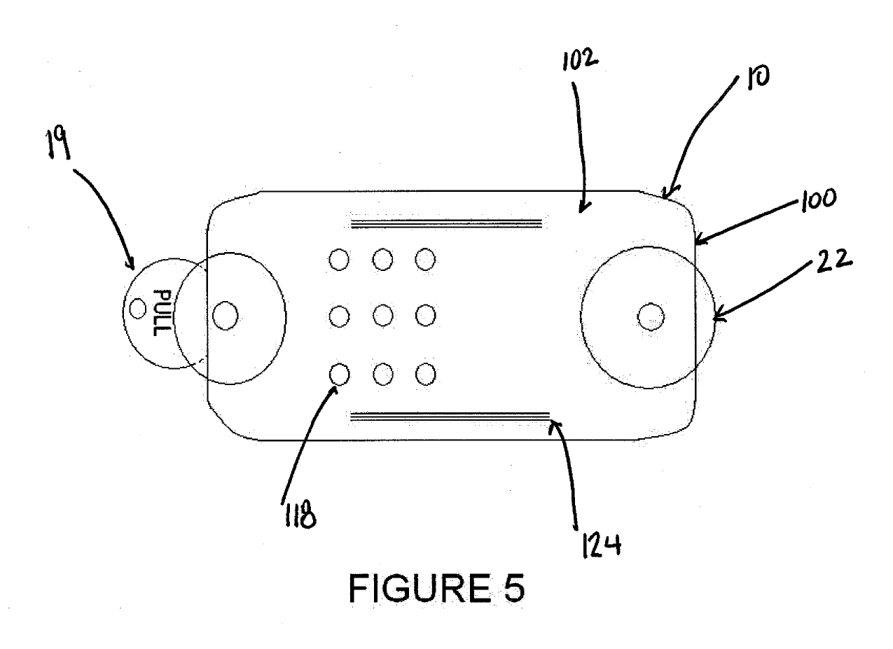

Yet another embodiment of the present invention 10, as shown in FIGS. 5-10 comprises a body portion 100 having a front face 102 and a back face 104. Said body portion 102 has a portion defining at least one hole or aperture 106 for use with the strobe light 12. Optionally, said body portion 100 has a portion defining a plurality of holes or apertures 106 for use with the strobe light 12. In addition said body portion 100 has a portion defining at least one hole 108 through which a least one suction cups 22 is removably fastened on the front face 102 by means of threaded studs or alternatively a hanging chain is threaded and supported therefrom. Finally, said body 100 may have a portion defining at least two slots 110.

Fixedly attached to the back face 104 of the body 100 is a PC board 112 having a PC Board front face 114 and a PC Board back face 116. The PC Board front face 114 is provided with at least one electronic circuit, which in turn is provided with at least one LED light 118 which forms the strobe light 12 and protrudes though the at least one hole 106 to extend above and jut out from the front face 102 of the body 100. Optionally, the

PC Board front face 114 is provided with at least one electronic circuit, which in turn is provided with a plurality of LED Lights 114 which protrude though the plurality of holes or apertures 106 and extend beyond and jut out from the surface of the front face 102 of the body 100. The PC Board 112 is further provided with a power source as for example a nine volt battery. The PC Board back face 104 is provided with a spring brass actuator 120 having two arms tensioned to be biased towards each other. The spring brass actuator 120 is maintained in the open position with a pull key 19 inserted between the spring brass actuator 120′s two self biasing arms. Upon withdrawal of the pull key 19 from in between the spring brass actuator's two self-biasing arms , the spring brass actuator 120's self biasing arms come together to close the circuit on the PC board 112, thereby allowing current to flow through the circuit to activate the LED lights. Such lights once activated flash with such strength and frequency that they create a strobe light 12 and permit the apparatus 10 to act as a beacon. The entire PC board 112 together with its power source and most of the shaft of the pull key 19 are covered and protected by a cover 122. The cover 122 is provided with at least two elongated flanges 124 which can be inserted and securely but removably locked into the slots 110 in the body 100. The head of the pull key 19 extends beyond the edge of the PC board, outside the cover 122 and beyond the outer perimeter of the body 100 such that it is readily visible, can be easily accessed and pulled to activate the strobe light 12, when and if the need arises.

The foregoing embodiment of the present invention can be utilized by the common user in a simple and effortless manner with little or no training. After a prior assembly of the apparatus 10 as indicated in FIGS. 1 and 2, and immediately following the occurrence of an emergency and an initial 911 call as indicated in the indicia 15, the method of utilizing the apparatus 10 may be achieved by performing the following steps in rapid succession: choosing a most visible location for displaying the apparatus 10; activating the strobe light 12 by means of either the power switch 14 the pull cord or pull key 19, or the remote unit 40; affixing the apparatus 10 onto the chosen location; firmly pushing the suction cups 22 in place or securing the hanger 24 onto an appropriate member of the structure or the vehicle; attending to the needs of the victim until the arrival of rescue personnel; turning the strobe light 12 off after arrival of the rescue personnel as for example by inserting the pull key back into the apparatus thereby preventing the spring brass actuator from closing the circuit; rendering whatever assistance the rescue personnel needs; depending on the design, recharging or replacing the battery in order to ensure a full charge for a subsequent reuse of the apparatus 10; and, returning the apparatus 10 to its visible and easily accessible storing location.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

Accordingly, what I claim is:

1. An emergency response locator beacon comprising:
a first enclosure to house a plurality of electrical circuitry components;
a strobe light protruding through a front surface of said first enclosure in electrical communication with said plurality of electrical components;
means connected to an activation switch in electrical communication with said plurality of electrical components; and
means to removably attach said first enclosure and said carrier when coupled to a desired support structure.
